(19) United States
(12) Patent Application Publication
(10) Pub. No.: US 2024/0373116 A1
(43) Pub. Date: Nov. 7, 2024

(54) DEVICE AND METHOD FOR ALERTING A USER FOR CAPTURING DIGITAL EVIDENCE THAT IS NOT IN COMPLIANCE WITH EVIDENTIARY POLICIES

(71) Applicant: MOTOROLA SOLUTIONS, INC, Chicago, IL (US)

(72) Inventors: KWANG CHUN OH, GEORGETOWN (MY); BRYAN CHIEW, KUALA LUMPUR (MY); NUR SYAHIRAH SYAFINAZ MOHD YUSOFF, TASEK GELUGOR (MY); MOHD ANUAR, KULIM (MY); MUHAMMAD IHSAN MAZID, PERAI (MY)

(21) Appl. No.: 18/312,603

(22) Filed: May 5, 2023

(51) Int. Cl. H04N 23/61; H04N 7/18

(52) U.S. Cl. CPC H04N 23/61; H04N 7/185

(57) ABSTRACT

A process for alerting a user for capturing digital evidence that is not in compliance with evidentiary policies. In operation, an electronic computing device acquires audio and/or video recordings from audio and/or video recorders operated by a user while the user is performing an assigned task. The device retrieves an evidentiary policy established corresponding to a particular type of the assigned task. The evidentiary policy identifies a list of evidentiary objects required to be digitally recorded in the audio and/or video recordings captured corresponding to the user's assigned task. If the audio and/or video recordings do not record at least one evidentiary object identified in the evidentiary policy with a specified quality level, then the device provides an electronic alert to the user indicating that the audio and/or video recordings are not in compliance with the evidentiary policy.

### BACKGROUND

Audio and video recordings are valuable forms of digital evidence as they capture events in a way that can be difficult to be replicated through other forms of documentation. Audio and video recordings can be especially important in situations where there is a need to identify who is responsible for a particular event or action or when there is a need to determine if a particular task was performed in compliance with established policies. However, when audio or video content is incomplete, distorted, or otherwise inaccurate, the use of such recordings as evidence in legal or investigative proceedings can be problematic.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a system in accordance with some embodiments.

FIG. 2 is a block diagram of an electronic computing device shown in FIG. 1 in accordance with some embodiments.

FIG. 3 illustrates a flowchart of a process for alerting a user for capturing digital evidence that is not in compliance with evidentiary policies in accordance with some embodiments.

FIG. 4 illustrates examples of evidentiary policies in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

Audio and video recordings can provide valuable insights into a situation, allowing individuals to observe and analyze the events that occurred. In legal proceedings, such recordings can be used to provide evidence of a crime or to show the actions of a suspect or an officer. In recent times, audio and video recordings from cameras such as body-worn cameras are increasingly used to assess if the actions of an officer during an interaction with a suspect or public are in compliance with department policies and rules. For example, a public-safety agency may require that the body-worn camera be turned on for recording an officer reciting the legal rights (e.g., Miranda warnings) to an individual during an arrest of the individual. Audio and video recordings are also increasingly used by private and non-public safety organizations as digital evidence. For example, hospitals may have a policy requiring their doctors to record patients' consent to a treatment or a surgery to protect them from legal liability. As another example, banks may have a policy requiring their officers to turn on their cameras and record events involving withdrawal of large amounts of cash by customers.

When audio and video recordings captured by cameras are distorted, incomplete, or unclear, such recordings may lose their evidentiary value and will no longer be useful as digital evidence for legal or investigatory purposes. For instance, a video recording may be incomplete or distorted when a field of view of a camera is blocked by clothing or other objects, or due to the camera lens being smeared with fingerprints. Similarly, an audio recording may be distorted or unclear when a user operating an audio recording device obstructs the port of the microphone. Accordingly, disclosed below is an improved process for alerting a user for capturing digital evidence that is not in compliance with evidentiary policies established for legal or investigatory purposes.

One embodiment provides a method for alerting a user for capturing digital evidence that is not in compliance with evidentiary policies. The method comprises: acquiring, at an electronic computing device, one or more audio and/or video recordings from one or more audio and/or video recorders operated by a user while the user is performing an assigned task; identifying, at the electronic computing device, a particular type of the assigned task; retrieving, at the electronic computing device, an evidentiary policy established corresponding to the particular type of the assigned task, the evidentiary policy identifying a list of evidentiary objects required to be digitally recorded in association with the particular type of the assigned task performed by the user, the evidentiary policy further specifying a quality level with which each of the evidentiary objects included in the list is to be recorded; determining whether each of the evidentiary objects included in the list is recorded in the one or more audio and/or video recordings at the quality level specified in the evidentiary policy; and responsive to determining that at least one of the evidentiary objects included in the list is not recorded with the specified quality level in the one or more of the audio and/or video recordings, providing an electronic alert to the user via a corresponding user device indicating that the one or more audio and/or video recordings are not in compliance with the evidentiary policy established corresponding to the particular type of the assigned task.

Another embodiment provides an electronic computing device. The electronic computing device includes a communications interface and an electronic processor communicatively coupled to the communications interface. The electronic processor is configured to: acquire, via the communications interface, one or more audio and/or video recordings from one or more audio and/or video recorders operated by a user while the user is performing an assigned task; identify a particular type of the assigned task; retrieve, via the communications interface, an evidentiary policy established corresponding to the particular type of the assigned task, the evidentiary policy identifying a list of evidentiary objects required to be digitally recorded in association with the particular type of the assigned task performed by the user, the evidentiary policy further specifying a quality level with which each of the evidentiary objects included in the list is to be recorded; determine whether each of the evidentiary objects included in the list is recorded in the one or more audio and/or video recordings at the quality level specified in the evidentiary policy; and responsive to determining that at least one of the evidentiary objects included in the list is not recorded with the specified quality level in the one or more of the audio and/or video recordings, provide an electronic alert to the user via a corresponding user device indicating that the one or more audio and/or video recordings are not in compliance with the evidentiary policy established corresponding to the particular type of the assigned task.

Each of the above-mentioned embodiments will be discussed in more detail below, starting with example system and device architectures of the system in which the embodiments may be practiced, followed by an illustration of processing blocks for achieving an improved technical method of alerting a user for capturing digital evidence that is not in compliance with evidentiary policies. Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

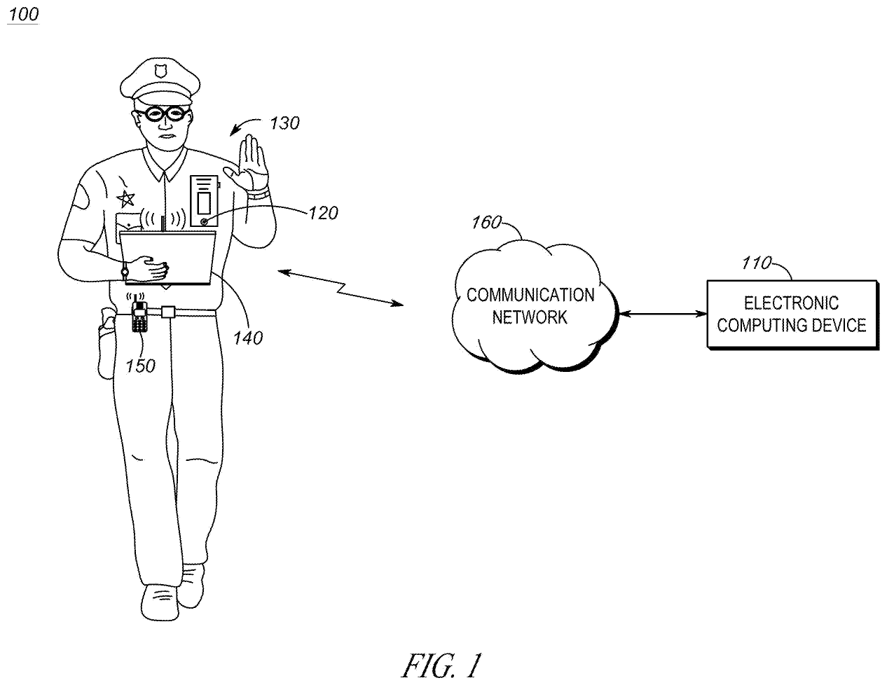

Referring now to the drawings, and in particular FIG. 1, a system 100 is shown including an electronic computing device 110 configured to communicate with one or more audio and/or video recorders 120 operated by a user 130 via one or more communication networks 160. The electronic computing device 110 is any infrastructure or client computing device that is adapted to provide electronic alert to users for capturing digital evidence that is not in compliance with evidentiary policies. In one embodiment, the electronic computing device 110 is implemented within the audio and/or video recorders 120. The audio and/or video recorders 120 include fixed or portable recording devices that can be controlled by the user 130 to capture digital evidence including audio and/or video recordings corresponding to a task performed by the user 130. As used herein, the term “audio and/or video recordings” covers one or more of audio-only recordings, video-only recordings, or both audio and video recordings. In accordance with some embodiments, as shown in FIG. 1, the audio and/or video recorders 120 may include a body-worn camera that is configured to capture both audio and video recordings. The audio and/or video recorder 120 may additionally or alternatively include other recording devices including surveillance cameras, vehicle cameras, mobile device cameras, drone cameras, and the like that are capable of being controlled by the user 130 to capture audio and video recordings or video-only recordings corresponding to a field of view of the respective recording devices. In some embodiments, the audio and/or video recorders 120 may additionally or alternatively include audio-only recorders such as microphones implemented at radios (e.g., portable radio 150) or ambient-listening devices that are capable of being controlled by the user 130 to capture audio-only recordings corresponding to, for example, conversations between persons (e.g., an officer and a suspect). In accordance with some embodiments, the electronic computing device 110 is authorized to acquire audio and/or video recordings captured by the audio and/or video recorders 120 substantially in real-time to when the recordings were captured at the audio and/or video recorders 120.

The audio and/or video recorders 120 may be issued to the user 130 by a public-safety agency (e.g., police department) or a non-public safety agency (e.g., hospital, bank etc.,) associated with the user 130. An agency employing the user 130 may have an evidentiary policy identifying a predefined list of evidentiary objects that the user 130 is required to capture as digital evidence while the user 130 is performing an assigned task. For example, when the user 130 is a police officer as shown in FIG. 1, the officer's agency may issue an audio and/or video recorder 120 such as a body-worn camera to the officer and may further require the officer to capture digital evidence including audio and/or video recordings corresponding to vehicle plate number, driver's face, driving license, vehicle color and make etc., whenever the officer performs a vehicle stop. As another example, when the user 130 is a doctor employed by a hospital, the hospital may issue an audio and/or video recorder 120 such as a voice recorder and may further require the doctor to activate the voice recorder and capture digital evidence including audio recordings corresponding to doctor's disclosure of risks associated with different treatment options available to a patient as well as audio recordings indicating patient's consent to a particular one of the treatment options. As used herein, the term “user” may refer to anyone who is required (e.g., as a function of the user's role or assigned task) to operate (e.g., by switching ‘ON’) the audio and/or video recorder 120 (e.g., body-worn camera) to capture digital evidence corresponding to an assigned task (e.g., vehicle stop, arrest, obtaining patient's consent to treatment etc.,) in compliance with an evidentiary policy established by an agency associated with the user 130.

In accordance with embodiments, the electronic computing device 110 provides an electronic alert to the user 130 via one or more devices (referred herein as “user device) associated with the user 130 to indicate that one or more audio and/or video recordings captured while the user 130 was performing an assigned task are not in compliance with an evidentiary policy established corresponding to a particular type of task performed by the user 130. The term “user device” refers to any electronic device that is capable of providing an electronic alert in any form (e.g., visual, acoustic, or haptic) to indicate that one or more audio and/or video recordings captured on the audio and/or video recorders 120 are not in compliance with an evidentiary policy established corresponding to a particular type of the task performed by the user 130. For example, the user device may include devices such as a tablet computing device 140 or a portable radio 150 as shown in FIG. 1. In this example, the electronic alert provided by the electronic computing device 110 may be provided on the tablet computing device 140 or portable radio 150 as text, audio, or video messages. In one embodiment, the electronic alert is additionally or alternatively provided on the audio and/or video recorders 120. As an example, the audio and/or video recorders 120 may provide the electronic alert in the form of sound, vibration, or visual feedback in response to receiving a signal from the electronic computing device 110 indicating that the audio and/or video recordings captured corresponding to the user's assigned task are not in compliance with an evidentiary policy established for the particular type of task performed by the user 130.

The electronic computing device 110 communicates with the audio and/or video recorders 120 and other user devices such as the tablet computing device 140 and the portable radio 150 via one or more communication networks 160. For example, the electronic computing device 110 acquires audio and/or video recordings captured by the audio and/or video recorders 120 via the communication network 160 for the purpose of processing the audio and/or video recordings and determining whether the audio and/or video recordings are in compliance with an evidentiary policy. Also, the electronic computing device 110 may transmit an electronic alert to a user device (e.g., audio and/or video recorder 120, tablet computing device 140, or portable radio 150) via the communication network 160 for the purpose of alerting the user 130 that one or more audio and/or video recordings captured during the user's assigned task are not in compliance with the evidentiary policy. The electronic computing device 110 may also communicate with entities not shown in FIG. 1. For example, the electronic computing device 110 may access evidentiary policies from one or more databases maintained by the agency via the communication network 160. The communication network 160 includes wireless and wired connections. For example, the communication network 160 may be implemented using a wide area network, such as the Internet, a local area network, such as a Wi-Fi network, and personal area or near-field networks, for example a Bluetooth™ network. Portions of the communications network 160 may include a Long Term Evolution (LTE) network, a Global System for Mobile Communications (or Groupe Special Mobile (GSM)) network, a Code Division Multiple Access (CDMA) network, an Evolution-Data Optimized (EV-DO) network, an Enhanced Data Rates for GSM Evolution (EDGE) network, a 3G network, a 4G network, a 5G network, and combinations or derivatives thereof.

While only a single electronic computing device 110 is shown as being included in the system 100, the system 100 may include any number of electronic computing devices, each configured to process audio and/or video recordings captured by a different one or more of audio and/or video recorders 120 and to further alert a different one or more of users for capturing digital evidence that is not in compliance with evidentiary policies established corresponding to particular types of tasks performed by the respective users.

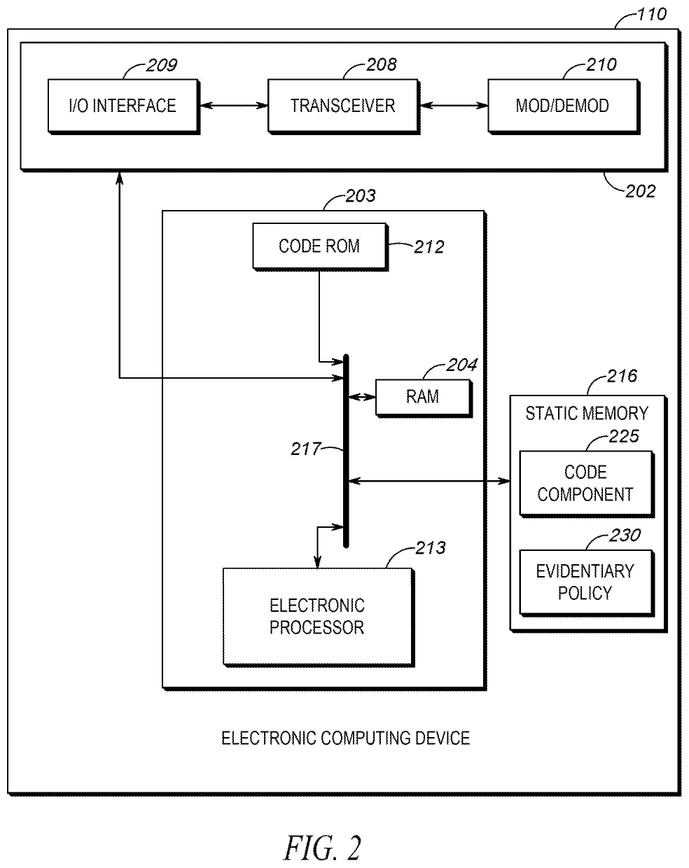

FIG. 2 is an example functional block diagram of an electronic computing device 110 operating within the system 100 in accordance with some embodiments. The electronic computing device 110 may be embodied in computing devices not illustrated in FIG. 1, and/or may be a distributed computing device across two or more of the foregoing (or multiple of a same type of one of the foregoing) and linked via a wired and/or wireless communication link(s). In one embodiment, one or more functions of the electronic computing device 110 can be implemented within the audio and/or video recorder 120. While FIG. 2 represents an electronic computing device 110 described above with respect to FIG. 1, depending on the type of electronic computing device 110, the electronic computing device 110 may include fewer or additional components in configurations different from that illustrated in FIG. 2.

As shown in FIG. 2, the electronic computing device 110 includes a communications unit 202 (also referred to as a “communications interface”) coupled to a common data and address bus 217 of a processing unit 203. The communications unit 202 sends and receives data to and from other devices in the system 100. The communications unit 202 may include one or more wired and/or wireless input/output (I/O) interfaces 209 that are configurable to communicate with other devices in the system 100. For example, the communications unit 202 may include one or more wireless transceivers 208, such as a DMR transceiver, a P25 transceiver, a Bluetooth transceiver, a Wi-Fi transceiver perhaps operating in accordance with an IEEE 802.11 standard (for example, 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network. The communications unit 202 may additionally or alternatively include one or more wireline transceivers 208, such as an Ethernet transceiver, a USB transceiver, or similar transceiver configurable to communicate via a twisted pair wire, a coaxial cable, a fiber-optic link, or a similar physical connection to a wireline network. The transceiver 208 is also coupled to a combined modulator/demodulator 210.

The processing unit 203 may include an encoder/decoder with a code Read Only Memory (ROM) 212 coupled to the common data and address bus 217 for storing data for initializing system components. The processing unit 203 may further include one or more electronic processors 213 (for example, a microprocessor, a logic circuit, an application-specific integrated circuit, a field-programmable gate array, or another electronic device) coupled, by the common data and address bus 217, to a Random Access Memory (RAM) 204 and a static memory 216. The electronic processor 213 may generate electrical signals and may communicate signals through the communications unit 202.

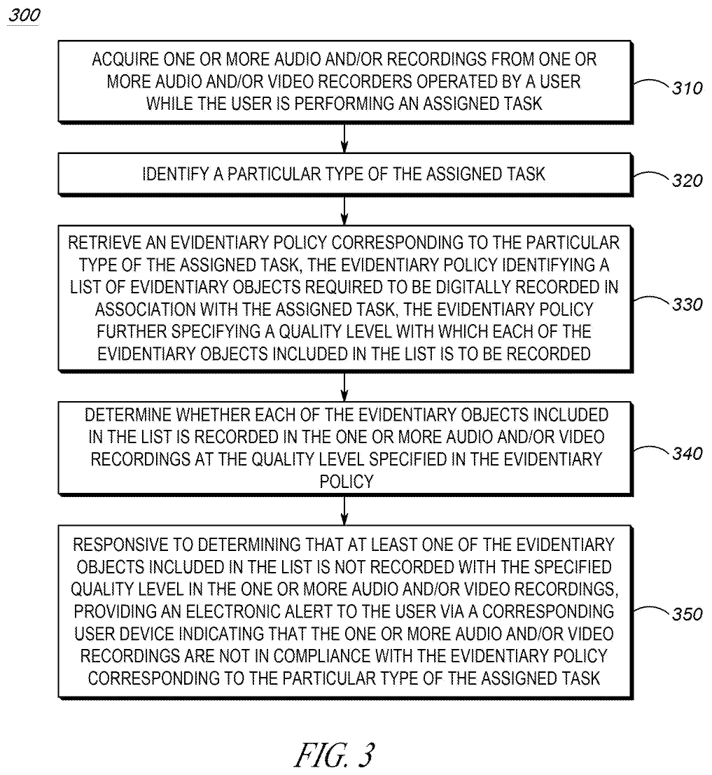

Static memory 216 may store operating code 225 for the one or more electronic processors 213 that, when executed, individually or collectively, performs one or more of the blocks set forth in FIG. 3, and the accompanying text(s). The static memory 216 may comprise, for example, a hard-disk drive (HDD), an optical disk drive such as a compact disk (CD) drive or digital versatile disk (DVD) drive, a solid state drive (SSD), a tape drive, a flash memory drive, or a tape drive, and the like. The static memory 216 may temporarily or permanently store audio and/or video recordings acquired from the audio and/or video recorders 120 for the purposes of alerting the user 130 for capturing digital evidence that is not in compliance with an evidentiary policy. In one embodiment, the electronic computing device 110 may obtain one or more evidentiary policies 230 (e.g., from a computing device of an agency associated with the user 130) established corresponding to different types of tasks assigned to a user 130. The evidentiary policies 230 are temporarily or permanently stored at the static memory 216.

Turning now to FIG. 3, a flowchart diagram illustrates a process 300 for alerting a user 130 for capturing digital evidence that is not in compliance with evidentiary policies 230. While a particular order of processing steps, message receptions, and/or message transmissions is indicated in FIG. 3 as an example, timing and ordering of such steps, receptions, and transmissions may vary where appropriate without negating the purpose and advantages of the examples set forth in detail throughout the remainder of this disclosure. An electronic computing device 110 shown in FIG. 1 and/or FIG. 2, and embodied as a singular computing device or distributed computing device may execute process 300 via one or more electronic processors 213.

The electronic computing device 110 may execute the process 300 at power-on, at some predetermined periodic time period thereafter, in response to a trigger raised locally at the electronic computing device 110 via an internal process or via an input interface or in response to a trigger from an external device (e.g., a computing device associated with a user operating the audio and/or video recorder 120) to which the electronic computing device 110 is communicably coupled, among other possibilities. As an example, the electronic computing device 110 is programmed to automatically trigger execution of the process 300 when the user 130 is assigned to a task or alternatively when an audio and/or video recorder 120 is activated, manually or automatically, to capture digital evidence corresponding to a task being performed by the user 130.

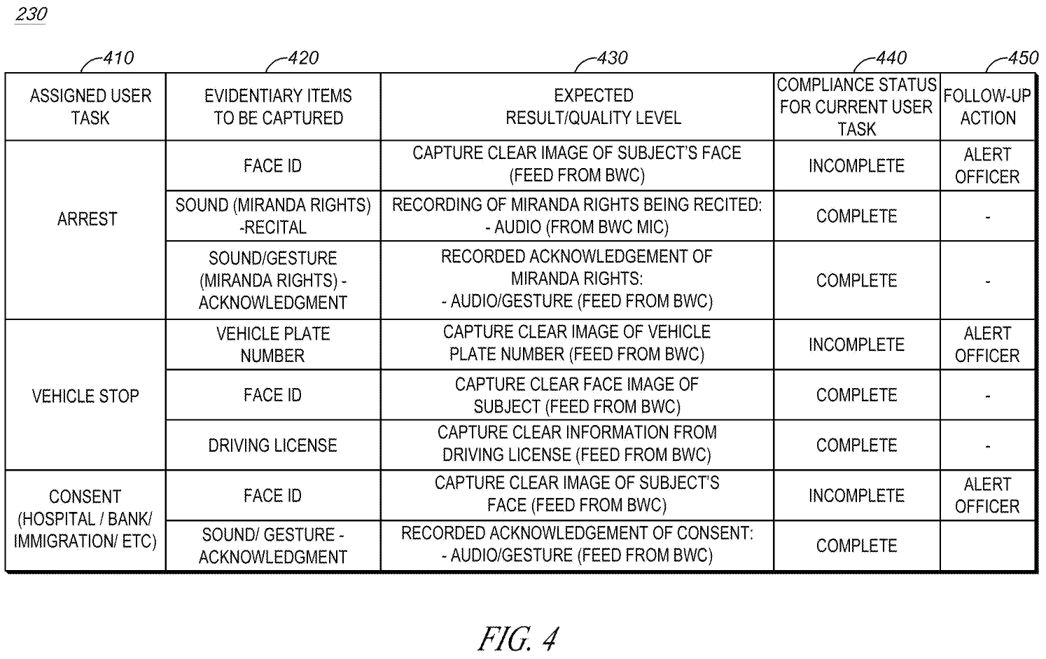

The process 300 of FIG. 3 need not be performed in the exact sequence as shown and likewise various blocks may be performed in different order or alternatively in parallel rather than in sequence. The process 300 may be implemented on variations of the system 100 of FIG. 1 as well. The process 300 will be described below with reference to FIG. 4 that provides examples of evidentiary policies 230 established by one or more agencies corresponding to tasks performed by users 130 associated with the respective agencies.

At block 310, the electronic computing device 110 acquires one or more audio and/or video recordings from one or more audio and/or video recorders 120 operated by a user 130 while the user 130 is performing an assigned task. In one embodiment, the electronic computing device 110 begins (e.g., by sending an electronic request to the audio and/or video recorders 120) to acquire audio and/or video recordings from the one or more audio and/or video recorders 120 in response to receiving a signal (e.g., from the audio and/or video recorder 120) indicating that the user 130 has activated (e.g., by switching ‘ON’) the audio and/or video recorders 120. In one embodiment, the audio and/or video recorder 120 is of a type that continuously captures and stores audio and/or video recordings. In this embodiment, the electronic computing device 110 begins to acquire audio and/or video recordings from the audio and/or video recorders 120 in response to receiving a signal (e.g., from a dispatch server that is configured to dispatch officers to a particular location such as an incident scene or assign a task associated with responding to an incident) indicating that the user 130 has begun to perform an assigned task (e.g., interviewing witnesses at the incident scene) of a particular type requiring digital evidence to be captured in compliance with evidentiary policy 230. In a further embodiment, the audio and/or video recorder 120 is of a device type that is automatically activated to capture digital evidence in response to detecting one or more triggering events (e.g., based on sensor data captured from sensors deployed in association with the user 130) in relation to the user 130 or the user's surroundings. For example, the triggering event may correspond to a change in state (presence or absence) and/or action (removal) relative to a weapon normally disposed within the user's 130 sensor-enabled holster. As another example, the triggering event may correspond to a threshold change in user's location, direction, steps, acceleration, speed, or health (e.g., as determined from one or more of a captured heart rate, a captured breathing rate, and a captured body temperature). In this embodiment, the electronic computing device 110 begins to acquire audio and/or video recordings from the audio and/or video recorders 120 in response to receiving a signal from one or more sensors indicating detection of one or more triggering events or alternatively in response to receiving a signal indicating that the audio and/or video recorder 120 has been automatically activated in response to the triggering events.

At block 320, the electronic computing device 110 identifies a particular type of the assigned task. In one embodiment, the electronic computing device 110 receives information about a particular type of task assigned to the user 130 from a computing resource (e.g., dispatch server) of an agency (e.g., a public safety agency) associated with the user 130. The computing resource may be a server or datastore from which the electronic computing device 110 can obtain information relating to one or more tasks assigned to and/or currently performed by the user 130. The electronic computing device 110 may also determine the type of assigned task based on one or more of the user identifier, user's role, user's agency, user's calendar schedule, type of devices (e.g., audio and/or video recorder 120), equipment, or tool carried by the user 130, or other information obtained from the computing resource of the agency. For instance, in a public-safety use case, the electronic computing device 110 may have access to a computer-aided dispatch database that maintains information relating to the type of tasks assigned to or performed in real-time by officers during a given time period. As an example, information accessed from the database may indicate that a particular officer (e.g., officer shown in FIG. 1) is currently performing or assigned to perform one or more of: a vehicle stop, an arrest, witness interview, or responding to a reported incident. The electronic computing device 110 may further determine that the audio and/or video recordings received from the user's audio and/or video recorders 120 at block 310 are related to the particular type of task (e.g., vehicle stop) currently performed by the user 130 based on a time correlation between the recordings and the assigned task. In a non-public safety use case, the electronic computing device 110 may similarly have access to a database maintained by a non-public safety agency (e.g., a hospital) with information relating to the type of tasks assigned to or performed in real-time by users 130 during a given time period. As an example, the database may include information relating to a doctor's appointment with a patient and a list of procedures that may be performed by the doctor during the appointment. In this example, based on the information received from a database maintained by the hospital, the electronic computing device 110 may determine that the doctor is scheduled to or currently performing a type of task (e.g., seeking the patient's consent to a particular type of treatment to be performed on the patient) that requires digital evidence to be captured in compliance with the hospital's evidentiary policy. In accordance with some embodiments, the electronic computing device 110 may identify a particular type of the assigned task performed by the user 130 before the electronic computing device begins to acquire audio and/or video recordings from one or more video recorders 120 operated by the user 130.

At block 330, the electronic computing device 110 retrieves an evidentiary policy 230 corresponding to the particular type of the assigned task identified at block 320. In accordance with some embodiments, the electronic computing device 110 first determines whether an agency associated with the user 130 requires audio and/or video recordings captured corresponding to the assigned task of particular type to be in compliance with one or more of the evidentiary policies 230 established by the agency. In these embodiments, if the electronic computing device 110 determines that the agency does not require audio and/or video recordings captured corresponding to the particular type of assigned task performed by the user 130 to be in compliance with any of the evidentiary policies 230 established by the agency, then the electronic computing device 110 does not further execute the functions described at blocks 340 and 350 and instead waits until the user 130 performs an assigned task that is of a type requiring audio and/or video recordings to be captured in compliance with an evidentiary policy 230 established by the agency. In these embodiments, the electronic computing device 110 may further refrain from acquiring subsequent audio and/or video recordings captured corresponding to the user's assigned task until the user 130 performs or is scheduled to perform an assigned task that is of a type requiring audio and/or video recordings to be captured in compliance with an evidentiary policy 230 established by the agency.

In accordance with some embodiments, the electronic computing device 110 receives the evidentiary policy 230 from one or more computing resources or databases maintained by an agency associated with the user 130. The electronic computing device 110 may further store the evidentiary policy 230 (e.g., at the static memory 216) and retrieve the evidentiary policy 230 as required to process the acquired audio and/or video recordings for compliance with the evidentiary policy 230. In accordance with some embodiments, the electronic computing device 110 retrieves the evidentiary policy as a function of the particular type of the task assigned to the user. In other words, each type of task performed by a user 130 may require corresponding digital evidence to comply with a different evidentiary policy. Accordingly, the electronic computing device 110 may retrieve only the evidentiary policy particularly established corresponding to the particular type of task performed by the user 130. In other embodiments, the electronic computing device 110 may pre-store a list of evidentiary policies established corresponding to different types of tasks that may be assigned to the user 130. In these embodiments, the electronic computing device 110 retrieves a particular evidentiary policy from the plurality of pre-stored evidentiary policies as a function of the task that is currently assigned to or performed by the user 130.

Briefly referring to FIG. 4, examples of evidentiary policies 230 are shown. The evidentiary policies 230 identify a list of evidentiary objects/items 420 that are required to be digitally recorded for different types of tasks 410 assigned to users 130. In accordance with embodiments, the evidentiary policies 230 further specify an expected result or a quality level 430 with which each of the evidentiary objects 420 (visual and/or audible objects) included in the list is to be recorded for respective types of assigned tasks 410. As an example, if the officer's task is to arrest an individual, then the evidentiary policy 230 established by a public-safety agency for the particular task of arresting an individual may require that the officer's body-worn camera be activated to clearly capture (e.g., a certain quality level) the face of the individual being arrested. The evidentiary policy 230 may also additionally require that an audio recording corresponding to an officer's recitation of the rights to the individual being arrested and the corresponding audio acknowledgment from the individual confirming that the individual has understood her rights. As another example, if the officer's task is to make a vehicle stop, then the evidentiary policy 230 established by a public-safety agency for the particular task of vehicle stop may require that the officer's body-worn camera be activated to clearly capture one or more of: an image of the vehicle plate number, driving license, driver's face etc. As a further example, an evidentiary policy 230 established by a hospital may require its doctors to capture digital evidence of a patient's consent (e.g., visually or audibly) to a particular type of treatment to be performed on the patient.

Returning to FIG. 3, at block 340, the electronic computing device 110 determines whether each of the evidentiary objects included in the list is recorded in the one or more audio and/or video recordings at the quality level specified in the evidentiary policy 230. In accordance with some embodiments, the electronic computing device 110 uses an analytics engine (e.g., implemented at the electronic computing device 110 or at a cloud computing system) to process the audio and/or video recordings and detect audible and/or visual objects recorded in the audio and/or video recordings. In accordance with some embodiments, the analytics engine includes a video analytics engine and/or an audio analytics engine. The video analytics engine includes one or more object classifiers that are particularly trained to identify an instance of a person or object or an attribute (e.g., face identification, tattoo, vehicle license plate, model or make of a vehicle, vehicle color etc.,) of the person or object captured in the audio recordings. The electronic computing device 110 uses the video analytics engine to detect visual objects recorded in the video recordings. For example, the visual objects may include, but not limited to, a person's face or other visual features (e.g., birthmarks, tattoos, scars, moles, clothing) appearing on the person or the background, and a gesture (e.g., head movement indicating confirmation or disagreement) made by the person. The visual objects may also include, but not limited to, inanimate objects including bags, vehicles, vehicle license plate, driving license or other identification from a person. The audio analytics engine similarly includes one or more audio classifiers that are particularly trained to identify an audible feature in an audio recording or an audio portion of the video recording. The audible feature may include, but not limited to, unique voice signature of a person, unique sound emanating from an object or the surroundings, predefined keywords or statements (e.g., reading of an individual's rights or an acknowledgment) made by a person.

As a result of processing the audio and/or video recordings using the analytics engine, the electronic computing device 110 detects a set of audible and/or visual objects recorded in the audio and/or video recordings. For each audible and/or visual object recorded in the audio and/or video recordings, the electronic computing device 110 verifies whether the audible and/or visual object is included in the list of evidentiary objects identified in the evidentiary policy 230. If a particular audible and/or visual object recorded in the audio and/or video recording is not included in the list of evidentiary objects, then the electronic computing device 110 does not further compute a measure of quality for the audible and/or visual object recorded in the audio and/or video recordings. On the other hand, if an audible and/or visual object recorded in the audio and/or video recording is included in the list of evidentiary objects to be captured corresponding to the assigned task, the electronic computing device 110 further computes a measure of quality for the audible and/or visual object recorded in the audio and/or video recordings. In one embodiment, the electronic computing device 110 computes a measure of quality for each audible and/or visual object by analyzing the corresponding portion of audio and/or video recordings as a function of one or more of: resolution, camera motion, bad exposure, frame sharpness, out-of-focus detection, brightness, overexposure on certain regions of the captured image, illumination, noisy frame detection, color temperature, shaking and rotation, blur, edge, scene composition, noise, etc. The electronic computing device 110 then assigns a quality score to each recorded audible and/or visual object (i.e., corresponding to evidentiary objects identified in the evidentiary policy 230) based on the analysis of a portion (e.g., frame) of the audio and/or video recording in which the audible and/or visual object is recorded. The measure of quality for each audible and/or visual object can be expressed in any suitable format. For example, the measure of quality is expressed in a numeric range between zero to ten, with zero representing low quality and ten representing high quality.

After computing the measure of quality for each audible and/or visual object recorded in the audio and/or video recordings and further included in the list of evidentiary objects identified in the evidentiary policy 230, the electronic computing device 110 determines whether the measure of quality associated with each audible and/or visual object recorded in the audio and/or video recordings meets the specified quality level in the one or more of the audio and/or video recordings. For example, referring to FIG. 4, if the audio and/or video recordings correspond to a task 410 such as a vehicle stop performed by an officer, then the electronic computing device 110 determines that the audio and/or video recordings should capture a list of evidentiary objects 420 including vehicle plate number, driver's face, and driving license. In this case, the electronic computing device 110 first checks whether each of the above evidentiary objects are digitally recorded in the audio and/or video recordings captured corresponding to the vehicle stop. If each of the vehicle plate number, driver's face, and driving license is digitally recorded in the audio and/or video recordings, then the electronic computing device 110 further checks whether a measure of quality computed for each of the above evidentiary objects meets an expected quality level 430 specified in the evidentiary policy 230. As an example, assume the evidentiary policy 230 requires each of the evidentiary objects to be captured with a minimum quality score of seven (7). Further assume that the electronic computing device 110 has analyzed the audio and/or video recordings and computed a quality score of six (6) for the vehicle plate number, a quality score of nine (9) for the driver's face, and a quality score for eight (8) for the driving license. In this example, since the vehicle plate number is not recorded with the quality level specified in the evidentiary policy 230, the electronic computing device 110 determines that at least one of the evidentiary objects (i.e., vehicle plate number) is not recorded with the specified quality level in the audio and/or video recordings captured corresponding to the user's assigned task (i.e., vehicle stop). In accordance with some embodiments, the electronic computing device 110 additionally tracks compliance status corresponding to each of the evidentiary objects required to be captured in order to alert the user 130 about the non-compliance. For example, as shown in FIG. 4, the electronic computing device 110 marks compliance status 440 corresponding to vehicle license plate number as “incomplete.” In accordance with some embodiments, marking compliance status as “incomplete” for any evidentiary object would trigger the electronic computing device 110 to perform a follow-up action 450 (e.g., send alert) on the compliance status.

At block 350, when the electronic computing device 110 determines that at least one of the evidentiary objects (e.g., vehicle plate number) included in the list is not recorded or when the electronic computing device determines that the measure of quality of the recorded evidentiary objects does not meet the specified quality level in the one or more of the audio and/or video recordings, the electronic computing device 110 provides an electronic alert to the user 130 via a corresponding user device (e.g., portable radio 150) indicating that the one or more audio and/or video recordings are not in compliance with the evidentiary policy 230 corresponding to the particular type of the assigned task. The electronic alert to the user 130 may be provided in the form of a visual, audible, or haptic alert to the user 130. In accordance with some embodiments, the electronic computing device 110 identifies, in the electronic alert, any evidentiary object listed in the evidentiary policy 230, but not recorded in the audio and/or video recordings with a quality level specified in the evidentiary policy 230. In this case, the electronic alert may provide an indication that the measure of quality associated with a particular audible and/or visual object (e.g., vehicle plate number) does not meet the quality level required by the evidentiary policy 230 established for the particular type of the assigned task. Additionally, the electronic alert may also identify any evidentiary object listed in the evidentiary policy 230, but not represented in any of the audible and/or visual objects recorded in the audio and/or video recordings captured corresponding to the user's assigned task. In this case, the electronic alert may provide an indication that a particular one of evidentiary objects (e.g., reading of an individual's rights) included in the list is not represented in any of the audible and/or visual objects recorded in the audio and/or video recordings captured corresponding to the user's assigned task (e.g. arrest). The electronic alert may also additionally identify evidentiary objects that have been recorded in the audio and/or video recordings with the quality levels specified in the evidentiary policies 230.

In accordance with some embodiments, the electronic computing device 110 further determines one or more actions that can be performed by the user 130 to capture digital evidence that would be in compliance with the evidentiary policy 230. As an example, assume an evidentiary object such as the license plate number is not captured with a quality level specified in the evidentiary policy 230. In this case, the electronic computing device 110 further identifies one or more factors (e.g., resolution, out-of-focus etc.,) that had an effect on the measure of quality of the evidentiary object such as the vehicle plate number recorded in the audio and/or video recording. The electronic computing device 110 then includes, in the electronic alert, a recommendation for the user 130 to adjust a position or configuration (e.g., adjust resolution or focus, or remove any items such as clothing blocking the camera's field of view etc.,) of the one or more audio and/or video recorders 120 to enable the user 130 to capture all the evidentiary objects in compliance with the evidentiary policy 230.

In accordance with embodiments, in response to providing an electronic alert to the user 130, the user 130 may adjust the position and/or configuration of the one or more audio and/or video recorders 120 operated by the user 130. In this case, the electronic computing device 110 acquires additional audio and/or video recordings from the audio and/or video recorders operated by the user 130 and repeats the process 300 unless one or more of: (i) all the evidentiary objects required by the evidentiary policy 230 are captured with the quality levels specified by the evidentiary policy 230, (ii) the audio and/or video recorder has been deactivated (e.g., camera switched ‘OFF’), or (iii) the user 130 is detected as no longer performing the assigned task. If the electronic computing device 110 determines that the user 130 is still performing an assigned task, then the electronic computing device 110 continues to acquire and process additional audio and/or video recordings corresponding to the user's assigned task. In accordance a with embodiments, as shown in FIG. 4, the electronic computing device 110 tracks the compliance status for each evidentiary object marked as “incomplete” and further updates the compliance status as “complete” when the electronic computing device 110 determines that the evidentiary object (previously marked as “incomplete”) is recorded with a specified quality level in the subsequent audio and/or video recordings received from the audio and/or video recorders 120 operated by the user 130 or from an audio and/or video recorder operated by another user.

In one embodiment, when the electronic computing device 110 determines that the audio and/or video recordings captured corresponding to the user's assigned task has recorded all the evidentiary objects with the quality level specified by the evidentiary policy 230, the electronic computing device 110 may provide an electronic notification to the user 130 or to another authorized user associated with the agency indicating that the audio and/or video recordings captured corresponding to the user's assigned task is in compliance with the evidentiary policy 230 established corresponding to the particular type of task performed by the user 130. The electronic notification may further include a summary report of evidentiary objects that are digitally captured in the audio and/or video recordings corresponding to the user's assigned task. The summary report of evidentiary objects includes, for example, an object identifier or name (e.g., “vehicle plate number”) uniquely identifying each evidentiary object recorded in the audio and/or video recordings captured corresponding to the user's assigned task and compliance status (e.g., “incomplete” or “complete”) indicating whether the object is recorded with the quality level specified in the evidentiary policy 230. Optionally, the electronic computing device 110 may store the audio and/or video recordings along with the summary report of evidentiary objects on an evidentiary database maintained by the agency.

In accordance with some embodiments, the electronic computing device 110 acquires multiple audio and/or video recordings captured corresponding to a duration of the assigned task, whether from audio and/or video recorders operated by a first user or from audio and/or video recorders operated by a second user who may be assisting the first user with the assigned task. In these embodiments, the electronic computing device 110 repeats blocks 320, 330, and 340 for each audio and/or video recording acquired from audio and/or video recorders operated by the first user or the second user. However, in these recordings, the electronic computing device 110 provides an electronic alert to the user 130 at block 350 only after determining that an evidentiary object identified in an evidentiary policy 230 established for the particular type of the assigned task is not captured in any of the multiple audio and/or video recordings (whether from the same user or from multiple users performing the same task) acquired by the electronic computing device 110. In other words, in these embodiments, the electronic computing device 110 refrains from providing an electronic alert to the user 130 when each evidentiary object identified in the evidentiary policy 230 is recorded with a specified quality level in at least one of the multiple audio and/or video recordings received by the electronic computing device 110.

As should be apparent from this detailed description, the operations and functions of the computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for alerting a user for capturing digital evidence that is not in compliance with evidentiary policies, the method comprising:
acquiring, at an electronic computing device, one or more audio and/or video recordings from one or more audio and/or video recorders operated by a user while the user is performing an assigned task;
identifying, at the electronic computing device, a particular type of the assigned task;
retrieving, at the electronic computing device, an evidentiary policy established corresponding to the particular type of the assigned task, the evidentiary policy identifying a list of evidentiary objects required to be digitally recorded in association with the particular type of the assigned task performed by the user, the evidentiary policy further specifying a quality level with which each of the evidentiary objects included in the list is to be recorded;
determining whether each of the evidentiary objects included in the list is recorded in the one or more audio and/or video recordings at the quality level specified in the evidentiary policy; and
responsive to determining that at least one of the evidentiary objects included in the list is not recorded with the specified quality level in the one or more of the audio and/or video recordings, providing an electronic alert to the user via a corresponding user device indicating that the one or more audio and/or video recordings are not in compliance with the evidentiary policy established corresponding to the particular type of the assigned task.

2. The method of claim 1, wherein the electronic alert identifies the at least one of the evidentiary objects.

3. The method of claim 1, wherein determining comprises:
processing the one or more audio and/or video recordings using an analytics engine to detect at least one audible and/or visual object recorded in the one or more audio and/or video recordings;
determining that the at least one audible and/or visual object is included in the list of evidentiary objects identified in the evidentiary policy;
computing a measure of quality with which the at least one audible and/or visual object is recorded in the one or more audio and/or video recordings;
determining whether the measure of quality associated with the at least one audible and/or video object meets the specified quality level required by the evidentiary policy for the particular type of assigned task; and
determining that the at least one of the evidentiary objects included in the list is not recorded with the specified quality level in the one or more of the audio and/or video recordings when the measure of quality associated with the at least one audible and/or visual object does not meet the quality level.

4. The method of claim 3, wherein the electronic alert indicates that the measure of quality associated with the at least one audible and/or visual object does not meet the specified quality level required by the evidentiary policy established for the particular type of assigned task.

5. The method of claim 1, wherein determining comprises:
processing the one or more audio and/or video recordings using an analytics engine to detect a plurality of audible and/or visual objects recorded in the one or more audio and/or video recordings;
determining whether each of the evidentiary objects included in the list identified in the evidentiary policy is represented in at least one of the audible and/or visual objects recorded in the one or more audio and/or video recordings; and
determining that the at least one of the evidentiary objects included in the list is not recorded in the one or more of the audio and/or video recordings when the at least one of the evidentiary objects included in the list is not represented in at least one of the audible and/or visual objects recorded in the one or more audio and/or video recordings.

6. The method of claim 5, wherein the electronic alert indicates that the at least one of the evidentiary objects included in the list is not represented in any of the audible and/or visual objects recorded in the one or more audio and/or video recordings.

7. The method of claim 1, wherein the electronic alert further includes a recommendation for the user to adjust a position or configuration of the one or more audio and/or video recorders.

8. The method of claim 1, wherein prior to providing the electronic alert, the method further comprising:
acquiring at least one other audio and/or video recording from either the one or more audio and/or video recorders operated by the user or from another audio and/or video recorder operated by at least one other user while the user is performing the assigned task; and
determining whether the at least one of the evidentiary objects included in the list is recorded with the specified quality level in the at least one other audio and/or video recording.

9. The method of claim 8, further comprising:
refraining from providing the electronic alert when the at least one other audio and/or video recording when the at least one of the evidentiary objects included in the list is recorded with the specified quality level in the at least one other audio and/or video recording.

10. The method of claim 8, further comprising:
providing the electronic alert when the at least one of the evidentiary objects included in the list is not recorded with the specified quality level in the at least one other audio and/or video recording.

11. The method of claim 1, wherein the one or more audio and/or video recorders is a body-worn camera.

12. An electronic computing device, comprising:
a communications interface; and
an electronic processor communicatively coupled to the communications interface, the electronic processor configured to:
acquiring, via the communications interface, one or more audio and/or video recordings from one or more audio and/or video recorders operated by a user while the user is performing an assigned task;
identify a particular type of the assigned task;
retrieve, via the communications interface, an evidentiary policy established corresponding to the particular type of the assigned task, the evidentiary policy identifying a list of evidentiary objects required to be digitally recorded in association with the particular type of the assigned task performed by the user, the evidentiary policy further specifying a quality level with which each of the evidentiary objects included in the list is to be recorded;
determine whether each of the evidentiary objects included in the list is recorded in the one or more audio and/or video recordings at the quality level specified in the evidentiary policy; and
responsive to determining that at least one of the evidentiary objects included in the list is not recorded with the specified quality level in the one or more of the audio and/or video recordings, provide an electronic alert to the user via a corresponding user device indicating that the one or more audio and/or video recordings are not in compliance with the evidentiary policy established corresponding to the particular type of the assigned task.

13. The electronic computing device of claim 12, wherein the electronic alert identifies the at least one of the evidentiary objects.

14. The electronic computing device of claim 12, wherein the electronic processor is configured to:
process the one or more audio and/or video recordings using an analytics engine to detect at least one audible and/or visual object recorded in the one or more audio and/or video recordings;
determine that the at least one audible and/or visual object is included in the list of evidentiary objects identified in the evidentiary policy;
compute a measure of quality with which the at least one audible and/or visual object is recorded in the one or more audio and/or video recordings;
determine whether the measure of quality associated with the at least one audible and/or video object meets the specified quality level required by the evidentiary policy for the particular type of assigned task; and
determine that the at least one of the evidentiary objects included in the list is not recorded with the specified quality level in the one or more of the audio and/or video recordings when the measure of quality associated with the at least one audible and/or visual object does not meet the specified quality level.

15. The electronic computing device of claim 14, wherein the electronic alert indicates that the measure of quality associated with the at least one audible and/or visual object does not meet the specified quality level required by the evidentiary policy established for the particular type of assigned task.

16. The electronic computing device of claim 12, wherein the electronic processor is configured to:
process the one or more audio and/or video recordings using an analytics engine to detect a plurality of audible and/or visual objects recorded in the one or more audio and/or video recordings;
determine whether each of the evidentiary objects included in the list identified in the evidentiary policy is represented in at least one of the audible and/or visual objects recorded in the one or more audio and/or video recordings; and
determine that the at least one of the evidentiary objects included in the list is not recorded in the one or more of the audio and/or video recordings when the at least one of the evidentiary objects included in the list is not represented in at least one of the audible and/or visual objects recorded in the one or more audio and/or video recordings.

17. The electronic computing device of claim 16, wherein the electronic alert indicates that the at least one of the evidentiary objects included in the list is not represented in any of the audible and/or visual objects recorded in the one or more audio and/or video recordings.

18. The electronic computing device of claim 12, wherein the electronic alert further includes a recommendation for the user to adjust a position or configuration of the one or more audio and/or video recorders.

19. The electronic computing device of claim 12, wherein the electronic processor is configured to:
acquire, prior to providing the electronic alert, at least one other audio and/or video recording from either the one or more audio and/or video recorders operated by the user or from another audio and/or video recorder operated by at least one other user while the user is performing the assigned task;
determine whether the at least one of the evidentiary objects included in the list is recorded with the specified quality level in the at least one other audio and/or video recording; and
provide the electronic alert when the at least one of the evidentiary objects included in the list is not recorded with the specified quality level in the at least one other audio and/or video recording.

20. The electronic computing device of claim 12, wherein the one or more audio and/or video recorders is a body-worn camera.
